(19) United States
(12) Patent Application Publication
(10) Pub. No.: US 2023/0296883 A1
(43) Pub. Date: Sep. 21, 2023

(54) OPTICAL EXPANDER APPARATUS OF LARGE FIELD OF VIEW AND DISPLAY APPARATUS

(71) Applicant: Shenzhen Optiark Semiconductor Technologies Limited, Shenzhen (CN)

(72) Inventors: HOUQIANG JIANG, Shenzhen (CN); Tapani Kalervo Levola, Shenzhen (CN); YISHENG ZHU, Shenzhen (CN)

(21) Appl. No.: 17/655,309

(22) Filed: Mar. 17, 2022

(51) Int. Cl. G02B 27/00; F21V 8/00; G02B 27/10; G02B 27/01

(52) U.S. Cl. CPC G02B 27/0081; G02B 6/0016; G02B 6/0036; G02B 27/0172; G02B 27/1086; G02B 2027/0125

(57) ABSTRACT

Disclosed are an optical expander apparatus, and a display apparatus. The optical expander apparatus comprises a waveguide plate, which in turn comprises:
an in-coupling element to form first guided light by diffracting input light,
a beam-split element to form second guided light by diffracting the first guided light,
a first expander element to form third guided light by diffracting the second guided light,
a second expander element to form fourth guided light by diffracting the first guided light, and
an out-coupling element to form first output light by diffracting the third guided light, and to form second output light by diffracting the fourth guided light,
wherein the out-coupling element is arranged to form combined output light by combining the first output light with the second output light,
wherein the beam-split element has a same first grating period as the first expander element, and the second expander element has a different second grating period from the first expander element.

### TECHNICAL FIELD

The present invention relates to an optical expander apparatus of a large field of view and display apparatus.

### BACKGROUND

Referring to FIG. 1, an expander apparatus EPE0 comprises a waveguide plate SUB01, which in turn comprises a diffractive in-coupling element DOE01, a diffractive expander element DOE02, and a diffractive out-coupling element DOE03. The expander apparatus EPE0 forms output light OUT1 by diffractively expanding light of an input light beam IN1 for a plurality of times.

The input light IN1 is generated by an optical engine ENG1. The optical engine ENG1 may comprise a micro display DISP1 and a collimating optical device LNS1.

The diffractive in-coupling element DOE01 forms first guided light B1 by diffracting the input light IN1. The diffractive expander element DOE02 forms expanded second guided light B2 by diffracting the first guided light B1. The diffractive out-coupling element DOE03 forms the output light OUT1 by diffracting the expanded second guided light B2.

The expander apparatus EPE0 may expand a light beam in two directions, direction SX and direction SY. The width of the output light OUT1 is far greater than the width of the input light IN1. The expander apparatus EPE0 may be arranged to expand a viewing pupil of a virtual display device, so that an eye EYE1 has a larger comfortable observation position with respect to that of the virtual display device (large eyebox, large eye movement range). The eye EYE1 of an observer may see a displayed virtual image in an observation position of the output light. The output light may comprise one or more output light beams, wherein each output light beam may correspond to a different image point of a displayed virtual image VIMG1. The expander apparatus may also be called e.g. as an expander unit or an expander element.

The virtual image VIMG1 has an angular width LIM1. An attempt to use the expander apparatus EPE0 of FIG. 1 for displaying a multi-color virtual image VIMG1 may cause a situation where red or blue light corresponding to a corner point of the virtual image VIMG1 does not fulfill the criterion of total internal reflection when propagating in the waveguide plate SUB01. Consequently, one or more corner regions of the displayed multi-color virtual image VIMG1 may exhibit a lack of red or blue color.

In the solution of CN112817153A, an expander apparatus is provided to solve a problem that a corner of a virtual image VIMG1 exhibits a lack of red or blue color. However, because incident light splits an in-coupling element into two semi-circles, a single-color complete image transmitted by a path is only coupled from one of the two semi-circles (the other path cannot or can only partially transmit the color image), an image energy of the single path is derived from only an in-coupling area of a semi-circle, and the image energy is too small, which needs to be further improved.

### SUMMARY

An object is to provide an expander apparatus. An object is to provide a display apparatus. The expander apparatus may be arranged to provide an extended field of view (FOV).

According to an aspect, there is provided an optical expander apparatus (EPE1) comprising:
a waveguide plate (SUB1) comprising:
   an in-coupling element (DOE1) to form first guided light (B1b) by diffracting input light (IN1),
   a beam-split element (DOEbs) to form second guided light (B1a) by diffracting first guided light (B1b),
   a first expander element (DOE2a) to form third guided light (B2a) by diffracting the second guided light (B1a),
   a second expander element (DOE2b) to form fourth guided light (B2b) by diffracting the first guided light (B1b), and
   an out-coupling element (DOE3) to form first output light (OB3a) by diffracting the third guided light (B2a), and to form second output light (OB3b) by diffracting the fourth guided light (B2b),
wherein the out-coupling element (DOE3) is arranged to form combined output light (OUT1) by combining the first output light (OB3a) with the second output light (OB3b),
wherein the first expander element (DOE2a) has a first grating period (d₂ₐ) for forming the third guided light (B2a), and wherein the second expander element (DOE2b) has a different second grating period (d_{2b}) for forming the fourth guided light (B2b).

Other embodiments are defined in the claims.

The scope of protection sought for various embodiments of the invention is set out by the independent claims. The embodiments, if any, described in this specification that do not fall under the scope of the independent claims are to be interpreted as examples useful for understanding various embodiments of the invention.

The expander apparatus may be arranged to display a color image, wherein the color image may have an extended width. The color image may be e.g. an RGB image, which comprises red (R) light, green (G) light, and blue (B) light.

Increasing the width of the displayed image may cause leakage of blue light and/or red light of the corner points of the displayed image. In other words, the in-coupling element of the expander apparatus may form red light or blue light, which cannot be confined to the waveguide plate by total internal reflection.

The expander apparatus may be arranged to provide two different routes for light, in order to overcome limitations set by the capability of the waveguide plate to guide light of different colors in directions, which correspond to a wide image.

The expander apparatus may split input light from the in-coupling element to propagate to the out-coupling element through the beam-split element via a first route and via a second route. The first route may pass from the beam-split element to the out-coupling element via the first expander element. The second route may pass from the beam-split element to the out-coupling element via the second expander element. The first route may be optimized e.g. for guiding blue light of a corner point, and the second route may be optimized e.g. for guiding red light of the corner point. Therefore, the expander apparatus may be arranged to display all corner points of an image in red and blue color. Red light of a corner point may be guided via at least one route, and blue light of the corner point may be guided via at least one route.

As a consequence of the optimization and the extended angular width of the displayed image, the first route may exhibit loss of red light of a corner point of the displayed image. The second route may exhibit loss of blue light of a corner point, respectively. However, red light propagating along the second route may at least partly compensate loss of red light from the first route. Blue light propagating along the first route may at least partly compensate loss of blue light from the second route.

The same in-coupling element is used for the two routes. This is because the display image usually presents in a rectangular sharp, e.g., with a display ratio of 16:9. The extended angular width in the short side direction is smaller compared to the long side direction. So, it is possible to choose a proper grating period and direction of the in-coupling element to ensure that blue and red light of the corner point are both confined to the waveguide plate to form first guided light.

The beam-split element may split for example blue light mainly from first guided light to form second guided light. A direction of propagation of the second guided light is different from the direction of propagation of the first guided light, and a grating period and a direction of the beam-split element may be designed, so that light, such as blue light and green light, of a corner point can be confined to the waveguide plate. The first guided light may partially pass through the beam-split element, and the propagation direction is not affected. Therefore, the image light in the waveguide forms two propagation routes after passing through the beam-split element.

The two routes may together at least partly compensate an error of the color of the corner point of the displayed image. The two routes may reduce or avoid an error of the color of the corner point of a wide displayed color image. The two routes may improve uniformity of color of a wide displayed color image.

The out-coupling element may form first output light by diffracting the third guided light, which propagates along the first route. The third guided light may be received from the first expander element. The out-coupling element may form second output light by diffracting the fourth guided light, which propagates along the second route. The fourth guided light may be received from the second expander element. The first output light may spatially overlap the second output light. The out-coupling element may form combined output light by combining the first output light with the second output light.

The out-coupling element may comprise first diffractive features to diffract guided light received from the first expander element. The out-coupling element may comprise second diffractive features to diffract guided light received from the second expander element. The first diffractive features may have a fourth grating period and the second diffractive features may have a different fifth grating period. The fourth grating period may be selected to ensure that blue guided light of a corner point is confined to the waveguide plate. The fifth grating period may be selected to ensure that red guided light of the corner point is confined to the waveguide plate. The first diffractive features may have a first orientation and the second diffractive features may have a different second orientation. The first diffractive features may have low or negligible efficiency for coupling light received from the second expander element. The second diffractive features may have low or negligible efficiency for coupling light received from the first expander element.

### BRIEF DESCRIPTION OF DRAWINGS

To describe the technical solutions in the embodiments of the present invention more clearly, the following briefly introduces the accompanying drawings required for describing the embodiments. Clearly, the accompanying drawings in the following description show some embodiments of the present invention, and a person of ordinary skill in the art may still derive other drawings from these accompanying drawings without creative efforts.

FIG. 1 shows a schematic structural diagram of an existing expander apparatus 20;

FIGS. 2a to 2e show, by way of example, in a three-dimensional view, forming incident light beams by using an optical engine;

FIG. 2f shows, by way of example, in a three-dimensional view, displaying a virtual image;

FIG. 2g shows, by way of example, angular width of a virtual image;

FIG. 2h shows, by way of example, angular height of a virtual image;

FIG. 3a is an example front view of an expander apparatus that provides two different routes for in-coupling light beams;

FIG. 3b is a schematic diagram of energy of an R channel in an RGB of an existing expander apparatus;

FIG. 3c is a schematic diagram of energy of a G channel in an RGB of an existing expander apparatus;

FIG. 3d is a schematic diagram of energy of a B channel in an RGB of an existing expander apparatus;

FIG. 3e is a schematic diagram of energy of an R channel in an RGB of the expander apparatus in FIG. 3a;

FIG. 3f is a schematic diagram of energy of a G channel in an RGB of the expander apparatus in FIG. 3a;

FIG. 3g is a schematic diagram of energy of a B channel in an RGB of the expander apparatus in FIG. 3a;

FIG. 4a shows, by way of example, in a three-dimensional view, a display apparatus, which comprises the expander apparatus;

FIG. 4b shows, by way of example, in cross-sectional side view, a display apparatus, which comprises the expander apparatus;

FIG. 5a shows, by way of example, wave vectors for blue light, which propagates along the first route of the expander apparatus according to an embodiment of the present invention;

FIG. 5b shows, by way of example, wave vectors for red light, which propagates along the first route of the expander apparatus according to an embodiment of the present invention;

FIG. 5c shows, by way of example, wave vectors for blue light of corner points of an image according to an embodiment of the present invention;

FIG. 5d shows, by way of example, wave vectors for blue light of corner points of an image according to an embodiment of the present invention;

FIG. 5e shows, by way of example, wave vectors for red light of corner points of an image according to an embodiment of the present invention;

FIG. 5f shows, by way of example, wave vectors for red light of corner points of an image according to an embodiment of the present invention;

FIG. 5g shows forming first guided light by coupling input light beams into a waveguide plate, wherein the inclination angle of the first guided light is close to the critical angle of total internal reflection according to an embodiment of the present invention;

FIG. 5h shows forming first guided light by coupling input light beams into a waveguide plate, wherein the inclination angle of the first guided light is close to 90 degrees according to an embodiment of the present invention;

FIG. 5i shows a relationship between the inclination angle of wave vector of the first guided light and the input angle of the wave vector of input light according to an embodiment of the present invention;

FIG. 6a shows, by way of example, wave vectors for blue light, which propagates along the second route of the expander apparatus according to an embodiment of the present invention;

FIG. 6b shows, by way of example, wave vectors for red light, which propagates along the second route of the expander apparatus according to an embodiment of the present invention;

FIG. 6c shows, by way of example, wave vectors for blue light of corner points of an image according to an embodiment of the present invention; and

FIG. 6d shows, by way of example, wave vectors for blue light of corner points of an image according to an embodiment of the present invention.

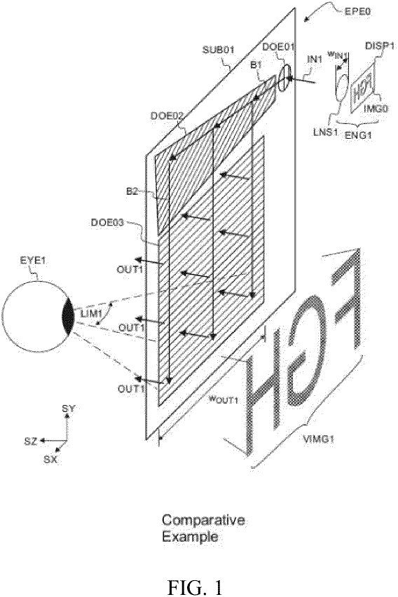

### DETAILED DESCRIPTION

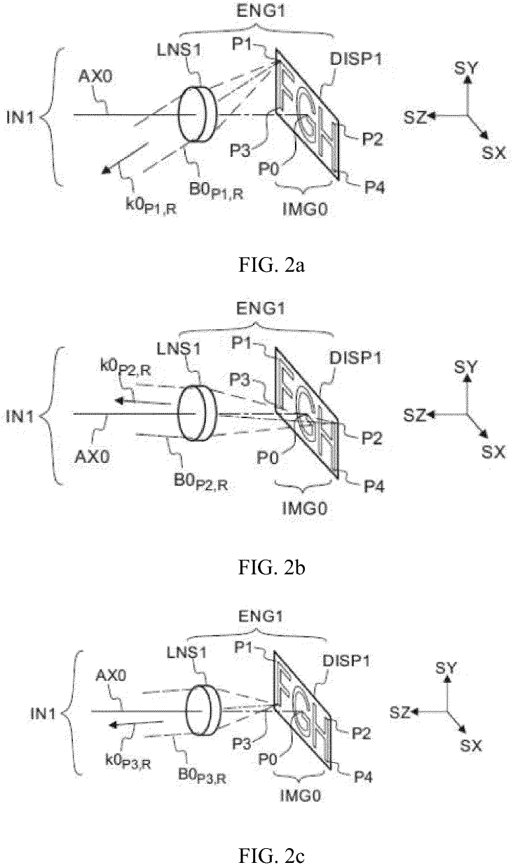

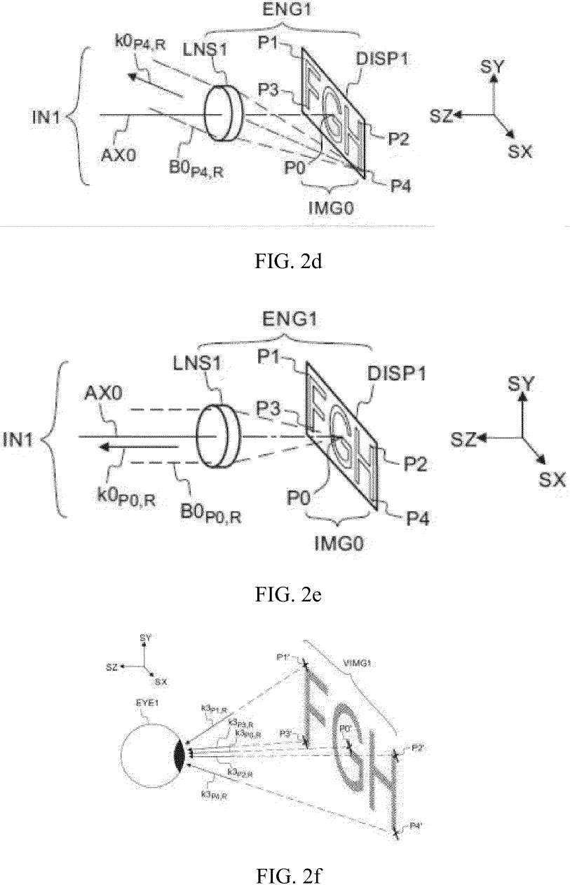

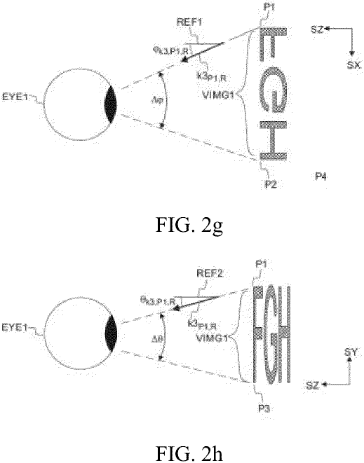

Referring to FIGS. 2a to 2e, an optical engine ENG1 may comprise a display DISP1 and a collimating optical device LNS1. The display DISP1 may be arranged to display an input image IMGO. The display DISP1 may also be called e.g. as a micro display. The display DISP1 may also be called e.g. as a spatial intensity modulator. The input image IMGO may also be called e.g. as an image source.

The input image IMGO may comprise a center point P0 and four corner points P1, P2, P3, and P4. P1 may denote an upper left corner point. P2 may denote an upper right corner point. P3 may denote a lower left corner point. P4 may denote a lower right corner point. The input image IMGO may comprise e.g. graphical characters “F”,“G”, and “H”.

The input image IMGO may be a color image. The input image IMGO may be e.g. an RGB image, which may comprise a red partial image, a green partial image, and a blue partial image. Each image point may provide e.g. red light, green light and/or blue light. The light of a red light beam may have red color, e.g. at a wavelength of 650 nm. The light of a green light beam may have a green color, e.g. at a wavelength of 510 nm. The light of a blue light beam may have a blue color, e.g. at a wavelength of 470 nm. In particular, light of a corner point of the color image IMGO may comprise red light and blue light.

The optical engine ENG1 may provide input light IN1, which may comprise a plurality of substantially collimated light beams (BO). Each red light beam may propagate in a different direction and may correspond to a different point of the input image IMGO. For example, a red light beam B0_{P1},_{R} may correspond to an image point P1, and may propagate in the direction of a wave vector k0_{P1},_{R}.

Also a blue light beam (B0_{P1},_{B}) may correspond to the same image point P1, and may propagate in the direction of a wave vector (k0_{P1},_{B}).

The input light IN1 may be formed such that the direction k0_{P1},_{B} of propagation of the blue light beam (B0_{P1},_{B}) corresponding to a first corner point P1 of the input image IMGO may be parallel with the direction k0_{P1,R} of propagation of the red light beam B0_{P1},_{R}.

The input light IN1 may be formed such that the direction k0_{P2},_{B} of propagation of a blue light beam B0_{P1},_{B} corresponding to a second corner point P2 of the input image IMG0 may be parallel with the direction k0_{P2,R} of propagation of a red light beam B0_{P2},_{R}, which corresponds to said second corner point P2.

A red light beam B0_{P2},_{R} may correspond to an image point P2, and may propagate in the direction of a wave vector k0_{P2},_{R}. A red light beam B0_{P3,R} may correspond to an image point P3, and may propagate in the direction of a wave vector k0_{P3},_{R}. A red light beam BO_{P4},_{R} may correspond to an image point P4, and may propagate in the direction of a wave vector k0_{P4},_{R}. A red light beam B0_{P0},_{R} may correspond to a central image point P0; and may propagate in the direction of a wave vector k0_{PO.R}.

The wave vector (k) of light may be defined as the vector having a direction of propagation of said light, and a magnitude given by 2π/λ, where λ is the wavelength of said light.

Referring to FIG. 2f, output light OUT1 may comprise a plurality of output light beams, which may correspond to a displayed virtual image VIMG1. Each output light beam may correspond to a point of the image. For example, a red light beam propagating in a direction of a wave vector k3_{P0},_{R} may correspond to a point P0′ of the image VIMG1. A red light beam propagating in a direction of a wave vector k3_{P1},_{R} may correspond to a point P1′ of the image VIMG1. A red light beam propagating in a direction of a wave vector k3_{P2},_{R} may correspond to a point P2′ of the image VIMG1. A red light beam propagating in a direction of a wave vector k3_{P3},_{R} may correspond to a point P3′ of the image VIMG1. A red light beam propagating in a direction of a wave vector k3_{P4.R} may correspond to a point P4′ of the image VIMG1.

An expander apparatus EPE1 may form the output light OUT1 by expanding the exit pupil of the optical engine ENG1. The output light OUT1 may comprise a plurality of output light beams, which correspond to the displayed virtual image VIMG1. The output light OUT1 may impinge on the eye EYE1 of an observer such that the observer may see the displayed virtual image VIMG1.

The displayed virtual image VIMG1 may have a center point P0′ and four corner points P1′, P2′, P3′, and P4′. The input light IN1 may comprise a plurality of light beams corresponding to the points P0; P1, P2, P3, and P4 of the input image IMGO. The expander apparatus EPE1 may form the point P0′ of the displayed virtual image VIMG1 by diffracting and guiding light of the point P0 of the input image IMGO. The expander apparatus EPE1 may form the points P1′, P2′, P3′, and P4′ by diffracting and guiding light of the points P1, P2, P3, and P4, respectively.

The expander apparatus EPE1 may form the output light OUT1, which comprises a plurality of light beams propagating in different directions specified by the wave vectors k3_{P0},_{R}, k3_{P1},_{R}, k3_{P2},_{R}, k3_{P3},_{R}, and k3_{P4,R}.

A red light beam corresponding to the point PO′ of the displayed virtual image VIMG1 has a wave vector k3_{P0},_{R}. A red light beam corresponding to the point P1′ of the virtual image VIMG1 has a wave vector k3_{P1},_{R}. A red light beam corresponding to the point P2′ of the virtual image VIMG1 has a wave vector k3_{P2},_{R}. A red light beam corresponding to the point P3′ of the virtual image VIMG1 has a wave vector k3_{P3},_{R}. A red light beam corresponding to the point P4′ of the virtual image VIMG1 has a wave vector k3_{P4},_{R}.

The expander apparatus EPE1 may be arranged to operate such that the wave vector k3p₁,_{R} is parallel with the wave vector k0_{P1},_{R} of the red light beam of the point P1 in the input light IN1. The wave vector k3_{P0},_{R} may be parallel with the wave vector k0_{P0,R} of the point P0. The wave vector k3_{P2},_{R} may be parallel with the wave vector k0_{P2,R} of the point P2. The wave vector k3_{P3,R} may be parallel with the wave vector k0_{P3,R} of the point P3. The wave vector k3_{P4,R} may be parallel with the wave vector k0_{P4,R} of the point P4.

Referring to FIGS. 2g and 2h, the displayed virtual image VIMG1 has an angular width Δφ and an angular height Δθ.

The displayed virtual image VIMG1 may have a first corner point P1′ e.g. at the left-hand side of the image VIMG1, and a second corner point P2′ e.g. at the right-hand side of the image VIMG1. The angular width Δφ of the virtual image VIMG1 may be equal to the horizontal angle between the wave vectors k3_{P1,R}, k3_{P2,R} of the corner points P1′, P2′.

The displayed virtual image VIMG1 may have an upper corner point P1′ and a lower corner point P3′. The angular height Δθ of the virtual image VIMG1 may be equal to the vertical angle between the wave vectors k3_{P1,R}, k3_{P3},_{R} of the corner points P1′, P3′.

The two routes of the expander apparatus EPE1 may allow displaying a wide color virtual image VIMG1. The two routes of the expander apparatus EPE1 may allow displaying a color virtual image VIMG1, which has an extended width Δφ.

The direction of a wave vector may be specified e.g. by orientation angles φ and θ. The angle φ may denote an angle between the wave vector and a reference plane REF1. The reference plane REF1 may be defined e.g. by the directions SZ and SY. The angle θ may denote an angle between the wave vector and a reference plane REF2. The reference plane REF2 may be defined e.g. by the directions SZ and SX.

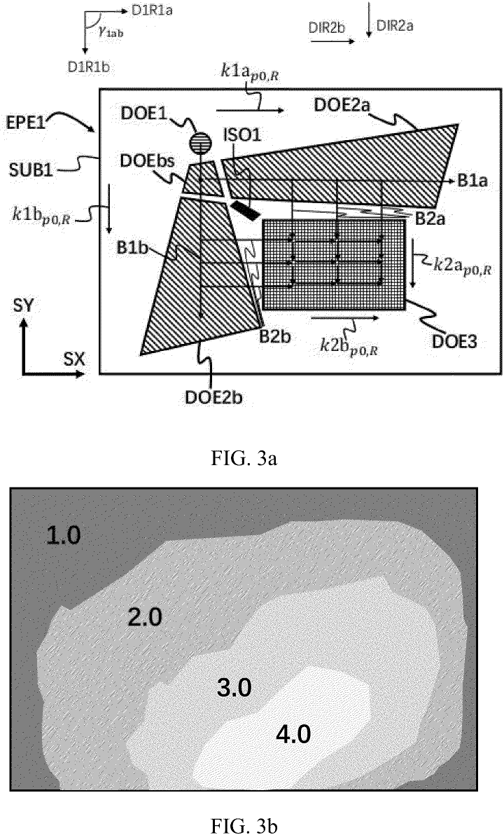

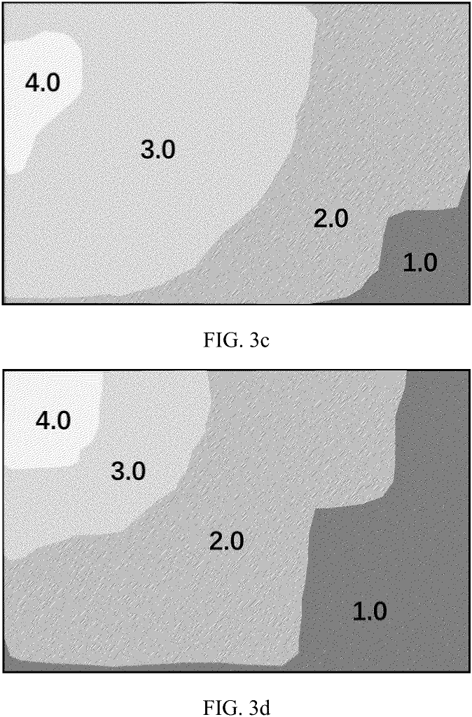

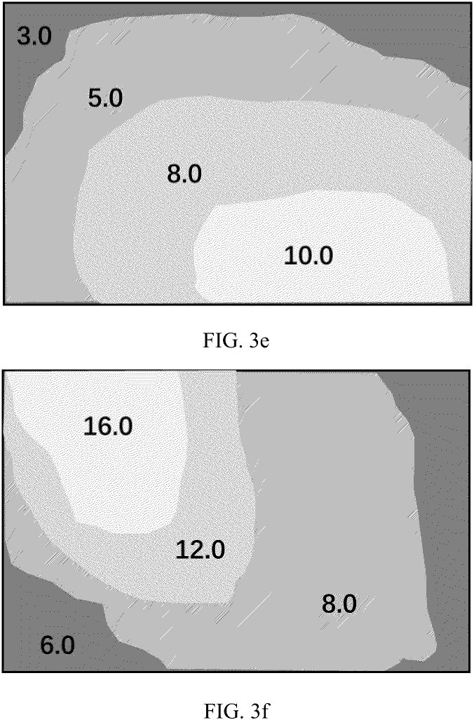

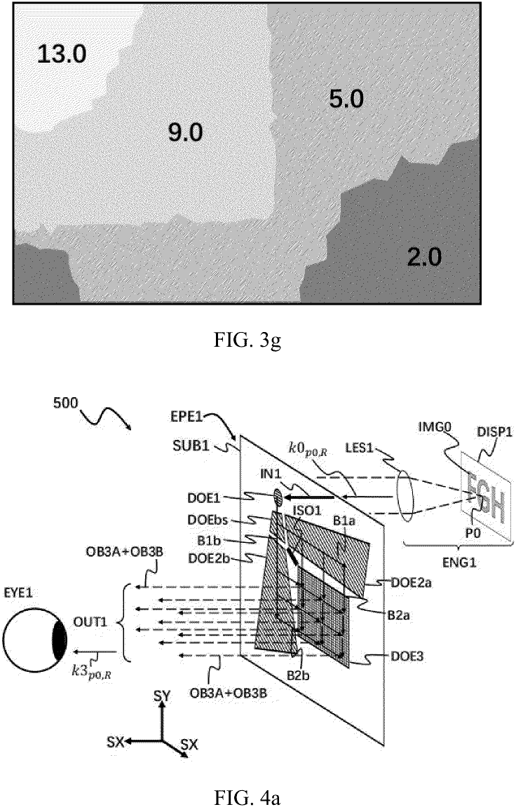

Referring to FIG. 3a, the expander apparatus EPE1 may comprise a substantially planar waveguide plate SUB1, which in turn may comprise a diffractive in-coupling element DOE1, a beam-split element DOEbs, a first expander element DOE2a, a second expander element DOE2b, and an out-coupling element DOE3. The gratings may be e.g. on first and/or second surface of the waveguide plate SUB1.

The in-coupling element DOE1 may receive input light IN1, and the out-coupling element DOE3 may provide output light OUT1. The input light IN1 may comprise a plurality of light beams propagating in different directions. The output light OUT1 may comprise a plurality of expanded light beams formed from the light beams (B0) of the input light IN1.

The width W_{OUT} of the output light OUT1 may be greater than the width w_{IN1} of the input light IN1. The expander apparatus EPE1 may expand the input light IN1 in two dimensions (e.g. in the horizontal direction SX and in the vertical direction SY). The expansion process may also be called as exit pupil expansion. The expander apparatus EPE1 may be called as a beam-expander apparatus or as an exit pupil expander.

The in-coupling element DOE1 may form first guided light B1b by diffracting the input light IN1. The beam-split element DOEbs may form second guided light B1a by partially diffracting the first guided light B1b. The first guided light B1b and the second guided light B1a may be waveguided within the planar waveguide plate SUB1. The first guided light B1b and the second guided light B1a may be confined to the waveguide plate SUB1 by total internal reflection.

The term “guided” may mean that the light propagates within the planar waveguide plate SUB1 so that the light is confined to the waveguide plate by total internal reflection (TIR). The term “guided” may mean the same as the term “waveguided”.

The in-coupling element DOE1 may couple the input light IN1 to form the first guided light. The beam-split element may split the first guided light to the out-coupling element DOE3 via two different routes, i.e. via the first expander element DOE2a and via the second expander element DOE2b. The expander apparatus EPE1 may provide a first route from the element DOE1 via the element DOEbs, then DOE2a to the element DOE3. The expander apparatus EPE1 may provide a second route from the element DOE1 via the element DOEbs, then DOE2b to the element DOE3. The first route may mean an optical path from the in-coupling element DOE1 to the out-coupling element DOE3 via the beam-split element and the first expander element DOE2a. The second route may mean an optical path from the in-coupling element DOE1 to the out-coupling element DOE3 via the beam-split element and the second expander element DOE2b.

The second guided light B1a may propagate from the beam-split element DOEbs to the first expander element DOE2a mainly in a first direction DIR1a. The first expander element DOE2a may form third guided light B2a by diffracting the second guided light B1a. The transverse dimension of the third guided light B2a may be greater than the corresponding transverse dimension of the input light IN1. The third guided light B2a may also be called e.g. as expanded guided light B2a.

The expanded guided light B2a may propagate from the first expander element DOE2a to the out-coupling element DOE3. The expanded guided light B2a may be confined to the waveguide plate SUB1 by total internal reflection.

The out-coupling element DOE3 may form first output light OB3a by diffracting the expanded guided light B2a.

The first guided light B1b may propagate from the in-coupling element DOE1 to the second expander element DOE2b via the beam-split element DOEbs mainly in a second direction DIR1b. The second expander element DOE2b may form fourth guided light B2b by diffracting the first guided light B1b. A transverse dimension of the fourth guided light B2b may be greater than the corresponding transverse dimension of the input light IN1. The fourth guided light B2b may also be called e.g. as expanded guided light B2b.

The expanded guided light B2b may propagate from the second expander element DOE2b to the out-coupling element DOE3. The expanded guided light B2b may be confined to the waveguide plate SUB1 by total internal reflection. The out-coupling element DOE3 may form second output light OB3b by diffracting the expanded guided light B2b.

The out-coupling element DOE3 may diffract the third guided light B2a received from the first expander element DOE2a, and the out-coupling element DOE3 may diffract the fourth guided light B2b received from the second expander element DOE2b.

The first direction DIR1a may mean the average propagation direction of the second guided light B1a. The first direction DIR1a may denote the central axis of propagation of the second guided light B1a.

The second direction DIR1b may mean the average propagation direction of the first guided light B1b. The second direction DIR1b may denote the central axis of propagation of the first guided light B1b.

The angle γ_{ab} between the first direction DIR1a and the second direction DIR1b may be e.g. in the range of 60° to 120°.

The expanded guided light B2a may propagate in a third direction DIR2a, which may be e.g. approximately parallel with the second direction DIR1b. The expanded guided light B2b may propagate in a fourth direction DIR2b, which may be e.g. approximately parallel with the first direction DIR1a.

The waveguide plate SUB1 may comprise one or more optically isolating elements ISO1 to prevent direct optical coupling between the first expander element DOE2a and the second expander element DOE2b. An optically isolating element ISO1 may be formed e.g. by depositing (black) absorbing materials on the surface of the waveguide plate, by adding (black) absorbing materials into a region of the waveguide plate, and/or by forming one or more openings into the waveguide plate.

SX, SY and SZ denote orthogonal directions. The waveguide plate SUB1 may be parallel with a plane defined by the directions SX and SY.

FIGS. 3b to 3d show energy output simulation images of exit pupil RGB of an expander apparatus, and FIGS. 3e to 3g show energy output simulation images of exit pupil RGB of an expander apparatus in CN112817153A. The simulation image represents the relative intensity of the image in the region by using a color, and a corresponding inside-color number is a relative average value of energy per unit area of the color region.

In the R channel, the average energy per unit area of the R channel simulation image displayed in FIG. 3b of CN112817153A is between 1.0 to 4.0, the average energy per unit area of the R channel simulation image of the expander apparatus in FIG. 3a is between 3.0 to 10.0, and in the R channel, the simulation energy of the expander apparatus in FIG. 3a is greater than the simulation energy of the expander apparatus in CN112817153A.

In the G channel, CN112817153A describes the average energy per unit area of a simulation image of the G channel shown in FIG. 3c is between 1.0 to 4.0, the average energy per unit area of a simulation image of the R channel in FIG. 3a is between 6.0 to 16.0, and in the G channel, the simulation energy of the expander apparatus in FIG. 3a is greater than the simulation energy of the expander apparatus in CN112817153A.

In the B channel, the average energy per unit area of the B channel simulation image displayed in FIG. 3d is between 1.0 to 4.0, the average energy per unit area of the R channel simulation image of the expander apparatus in FIG. 3a is between 2.0 to 13.0, and in the B channel, the simulation energy of the expander apparatus in FIG. 3a is greater than the simulation energy of the expander apparatus in CN112817153A.

In this way, the expander apparatus in FIG. 3a has a better energy effect and display effect than the expander apparatus in CN112817153A in terms of diffraction strength of the out-coupling element DOE3.

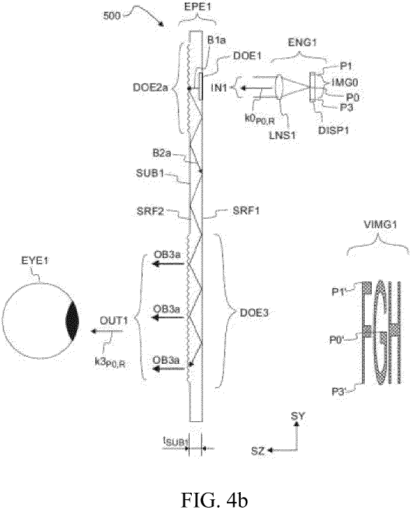

Referring to FIGS. 4a and 4b, the expander apparatus EPE1 may form output light OUT1 by diffracting and guiding input light IN1 obtained from an optical engine ENG1. A display apparatus 500 may comprise the optical engine ENG1 and the expander apparatus EPE1.

The input light IN1 may comprise a plurality of light beams propagating in different directions. Each light beam of the input light IN1 may correspond to a different point of the input image IMGO. The output light OUT1 may comprise a plurality of light beams propagating in different directions. Each light beam of the output light OUT1 may correspond to a different point of the displayed virtual image VIMG1. The expander apparatus EPE1 may form the output light OUT1 from the input light IN1 such that the directions and the intensities of the light beams of the output light OUT1 correspond to the points of the input image IMGO.

A light beam of the input light IN1 may correspond to a single image point (P0) of a displayed image. The expander apparatus EPE1 may form an output light beam from a light beam of the input light IN1 such that the direction (k_{3,P0,R}) of the output light beam is parallel with the direction (k_{0,P0,R}) of the corresponding light beam of the input light IN1.

The display apparatus 500 may comprise an optical engine ENG1 to form a primary image IMGO (i.e., the input image IMGO) and to convert the primary image IMGO into a plurality of light beams of the input light IN1. The engine ENG1 may be optically coupled to the in-coupling element DOE1 of the expander EPE1. The input light IN1 may be optically coupled to the in-coupling element DOE1 of the expander apparatus EPE1. The display apparatus 500 may be e.g. a display device for displaying virtual images. The display apparatus 500 may be a near eye optical device.

The expander apparatus EPE1 may carry virtual image content from the light engine ENG1 to the front of a user’s eye EYE1. The expander apparatus EPE1 may expand the viewing pupil, thus enlarging the eye box.

The engine ENG1 may comprise a micro-display DISP1 to generate a primary image IMGO. The micro-display DISP1 may comprise a two-dimensional array of light-emitting pixels. The display DISP1 may generate a primary image IMG0 e.g. at a resolution of 1280 × 720. The display DISP1 may generate a primary image IMGO e.g. at a resolution of 1920 × 1080 (Full HD).

The display DISP1 may generate a primary image IMGO e.g. at a resolution of 3840 × 2160 (4K UHD). The primary image IMGO may comprise a plurality of image points P0, P1, P2, .... The engine ENG1 may comprise a collimating optical device LNS1 to form a different light beam from each image pixel. The engine ENG1 may comprise a collimating optical device LNS1 to form a substantially collimated light beam from light of an image point P0. The light beam corresponding to the image point P0 may propagate in the direction specified by a wave vector k0_{P0,R}. A light beam corresponding to a different image point P1 may propagate in a direction k0_{P1},_{R} which is different from the direction k0_{P0,R}.

The engine ENG1 may provide a plurality of light beams corresponding to the generated primary image IMG0. The one or more light beams provided by the engine ENG1 may be coupled to the expander apparatus EPE1 as input light IN1.

The engine ENG1 may comprise e.g. one or more light emitting diodes (LED). The display DISP1 may comprise e.g. one or more micro display imagers, such as liquid crystal on silicon (LCOS), liquid crystal display (LCD), and digital micromirror device (DMD).

The out-coupling element DOE3 may form first output light OB3a by diffracting third guided light B2a received from the first expander element DOE2a. The out-coupling element DOE3 may form second output light OB3b by diffracting fourth guided light B2b received from the second expander element DOE2b. The out-coupling element DOE3 may form combined output light OUT1 by combining the first output light OB3a with the second output light OB3b.

The expander apparatus EPE1 may be arranged to operate such that the direction of light of a given image point (e.g. P0) in the first output light OB3a is parallel with the direction of light of said given image point (P0) in the second output light OB3b. Consequently, the combining the first output light OB3a with the second output light OB3b may form a combined light beam, which corresponds to said given image point (P0).

Each element DOE1, DOEbs, DOE2a, DOE2b, DOE3 may comprise one or more diffraction gratings to diffract light as described.

The grating periods (d) and the orientations (β) of the diffraction gratings of the optical elements DOE1, DOEbs, DOE2a, DOE2b, DOE3 may be selected such that the direction of each light beam of the output light OUT1 may be parallel with the direction of the corresponding light beam of the input light IN1.

The grating periods (d) and the direction (β) of the grating vectors may fulfill e.g. the condition that the vector sum (m₁ V₁+m_{bs} V_{bs}+m₂ₐ V₂ₐ+m₃ₐ V₃ₐ) is zero for predetermined integers m₁, m_{bs}, m₂ₐ, m₃ₐ. V₁ denotes a grating vector of the in-coupling element DOE1. V_{bs} denotes a grating vector of the beam-split element DOEbs. V₂ₐ denotes a grating vector of the first expander element DOE2a. V₃ₐ denotes a grating vector of the out-coupling element DOE3. The value of these integers is typically +1 or -1.

The grating periods (d) and the direction (β) of the grating vectors may fulfill e.g. the condition that the vector sum (m₁V₁+m_{2b}V_{2b}+m_{3b}V_{3b}) is zero for predetermined integers m₁, m_{2b}, m_{3b}. V₁ denotes a grating vector of the in-coupling element DOE1. V_{2b} denotes a grating vector of the first expander element DOE2b. V_{3b} denotes a grating vector of the out-coupling element DOE3. The value of these integers is typically +1 or -1.

The waveguide plate may have a thickness t_{SUB1}. The waveguide plate comprises a planar waveguiding core. In an embodiment, the waveguide plate SUB1 may optionally comprise e.g. one or more cladding layers, one or more protective layers, and/or one or more mechanically supporting layers. The thickness t_{SUB1} may refer to the thickness of a planar waveguiding core of the waveguide plate SUB1.

The expander apparatus EPE1 may expand a light beam in two transverse directions, the direction SX and the direction SY. The width (in the direction SX) of the output light OUT1 may be greater than the width of the input light IN1, and the height (in the direction SY) of the output light OUT1 may be greater than the height of the input light IN1.

The expander apparatus EPE1 may be arranged to expand a viewing pupil of the virtual display apparatus 500, so as to facilitate positioning of an eye EYE1 with respect to the virtual display apparatus 500. A human observer may see a displayed virtual image VIMG1 in a situation where the output light OUT1 is arranged to impinge on an eye EYE1 of the human viewer. The output light OUT1 may comprise one or more output light beams, wherein each output light beam may correspond to a different image point (P0′, P1′) of a displayed virtual image VIMG1. The engine ENG1 may comprise a micro display DISP1 for displaying a primary image IMGO. The engine ENG1 and the expander apparatus EPE1 may be arranged to display the virtual image VIMG1 by converting the primary image IMG0 into a plurality of input light beams (e.g. B0_{P0},_{R}, B0_{P1},_{R}, B0_{P2},_{R}, B0_{P3},_{R}, B0_{P4},_{R}, ..., B0_{P0,B}, B0_{P1},_{B}, B0_{P2},_{B}, B0_{P3},_{B}, B0_{P4},_{B}, ...), and by forming output light OUT1 from the input beams by expanding the input beams. For example, the notation B0_{P2},_{R} may mean an input light beam, which corresponds to an image point P2 and which has red (R) color. For example, the notation B0_{P2},_{B} may mean an input light beam, which corresponds to the image point P2 and which has blue (B) color. The input light beams may together constitute input light IN1. The input light IN1 may comprise a plurality of input light beams (e.g. B0_{P0,R}, B0_{P1,R}, B0_{P2,R}, B0_{P3,R}, B0_{P4,R}, ..., B0_{PQ,B}, B0_{P1,B}, B0_{P2,B}, B0_{P3,B}, B0_{P4,B}, ...).

The output light OUT1 may comprise a plurality of output light beams such that each output light beam may form a different image point (P0′, P1′) of the virtual image VIMG1. The primary image IMGO may be represented e.g. as graphics and/or text. The primary image IMGO may be represented e.g. as a video. The engine ENG1 and the expander apparatus EPE1 may be arranged to display the virtual image VIMG1 such that each image point (P0′, P1′) of the virtual image VIMG1 corresponds to a different image point of the primary image IMGO.

The waveguide plate SUB1 may have a first major surface SRF1 and a second major surface SRF2. The surfaces SRF1, SRF2 may be substantially parallel with the plane defined by the directions SX and SY.

A grating period (d) of a diffraction grating and the orientation (β) of the diffractive features of the diffraction grating may be specified by a grating vector V of said diffraction grating. The diffraction grating comprises a plurality of diffractive features (F) which may operate as diffractive lines. The diffractive features may be e.g. microscopic ridges or grooves. The diffractive features may also be e.g. microscopic protrusions (or recesses), wherein adjacent rows of protrusions (or recesses) may operate as diffractive lines. The grating vector V may be defined as a vector having a direction perpendicular to diffractive lines of the diffraction grating and a magnitude given by 2π/d, where d is the grating period.

The in-coupling element DOE1 may have a grating vector V₁. The beam-split element DOEbs may have a grating vector V_{bs}. The first expander element DOE2a may have a grating vector V₂ₐ. The second expander element DOE2b may have a grating vector V_{2b}. The out-coupling element DOE3 may have grating vectors V₃ₐ, V_{3b}.

The grating vector V₁ has a direction β₁ and a magnitude 2π/d₁. The grating vector V_{bs} has a direction β _{bs} and a magnitude 2 π /d_{bs}. The grating vector V₂ₐ has a direction β ₂ₐ and a magnitude 2π/d₂ₐ. The grating vector V_{2b} has a direction β_{2b} and a magnitude 2π/d_{2b}. The grating vector V₃ₐ has a direction β₃ₐ and a magnitude 2π/d₃ₐ. The grating vector V_{3b} has a direction β_{3b} and a magnitude 2π/d_{3b}. The direction (β) of a grating vector may be specified e.g. by the angle between said vector and a reference direction (e.g. direction SX).

The grating periods (d) and the orientations (β) of the diffraction gratings of the optical elements DOE1, DOEbs, DOE2a, DOE3 may be selected such that the direction (k3_{p0,R}) of propagation of light of the center point P0 in the first output light OB3a is parallel with the direction (k0_{p0,R}) of propagation of light of the center point P0 in the input light IN1.

The grating periods (d) and the orientations (β) of the diffraction gratings of the optical elements DOE1, DOE2a, DOE3 may be selected such that the direction (k3_{p0,R}) of propagation of light of the center point P0 in the second output light OB3b is parallel with the direction (k0_{P0,R}) of propagation of light of the center point P0 in the input light IN1.

The grating periods (d) and the orientations (β) of the diffraction gratings of the optical elements DOE1, DOE2a, DOE2b, DOE3 may be selected such that the direction (k3_{p0,R}) of propagation of light of the center point P0 in the combined output light OUT1 is parallel with the direction (k0_{P0,R}) of propagation of light of the center point P0 in the input light IN1.

An angle between the direction of the grating vector V₁ of the in-coupling element DOE1 and the direction of the grating vector V_{bs} of beam-split element DOEbs may be e.g. in the range of 60° to 120°.

The grating period d₂ₐ of the first expander element DOE2a may be different from the grating period d_{2b} of the second expander element DOE2b, for optimizing the first route for a first color, and for optimizing the second route for a different second color.

The first grating period d₃ₐ of the out-coupling element DOE3 may be different from the second grating period d_{3b} of the out-coupling element DOE3, for optimizing the first route for a first color, and for optimizing the second route for a different second color.

The out-coupling element DOE3 may have a first grating vector V3a to couple the expanded third guided light B2a out of the waveguide plate SUB1. The out-coupling element DOE3 may have a second grating vector V3b to couple the expanded fourth guided light B2b out of the waveguide plate SUB1. The out-coupling element DOE3 may have diffractive features F3a to provide a grating G3a which has a grating period d₃a and an orientation β₃ₐ with respect to the reference direction SX. The out-coupling element DOE3 may have diffractive features F3b to provide a grating G3b which has a grating period d_{3b} and an orientation β _{3b} with respect to the reference direction SX. The out-coupling element DOE3 may be implemented e.g. by a crossed grating or by two linear gratings. A first linear grating G3a having diffractive features F3a may be implemented on a first side (e.g. SRF1) of the waveguide plate SUB1, and a second linear grating G3b having diffractive features F3b may be implemented on the second side (e.g. SRF2) of the waveguide plate SUB1.

The in-coupling element DOE1 may have a width w₁ and a height h₁. The first expander element DOE2a may have a width w₂ₐ and a height h₂ₐ. The second expander element DOE2b may have a width W_{2b} and a height h_{2b}. The out-coupling element DOE3 may have a width w₃ and a height h₃.

The width may denote a dimension in the direction SX, and the height may denote a dimension in the direction SY. The out-coupling element DOE3 may be e.g. substantially rectangular. The sides of the out-coupling element DOE3 may be aligned e.g. with the directions SX and SY.

The width w₂ₐ of the expander element DOE2a may be substantially greater than the width w₁ of the in-coupling element DOE1. The width of the expanded third guided light B2a may be substantially greater than the width w1 of the in-coupling element DOE1.

The waveguide plate SUB1 may comprise or consist essentially of transparent solid material. The waveguide plate SUB1 may comprise e.g. glass, polycarbonate or polymethyl methacrylate (PMMA). The diffractive optical elements DOE1, DOEbs, DOE2a, DOE2b, DOE3 may be formed e.g. by molding, embossing, and/or etching. The elements DOE1, DOEbs, DOE2a, DOE2b, DOE3 may be implemented e.g. by one or more surface diffraction gratings or by one or more volume diffraction gratings.

The spatial distribution of diffraction efficiency may be optionally tailored e.g. by selecting the local elevation of the microscopic diffractive features F. The elevation of the microscopic diffractive features F of the out-coupling element DOE3 may be optionally selected so as to further homogenize the intensity distribution of the output light OUT1.

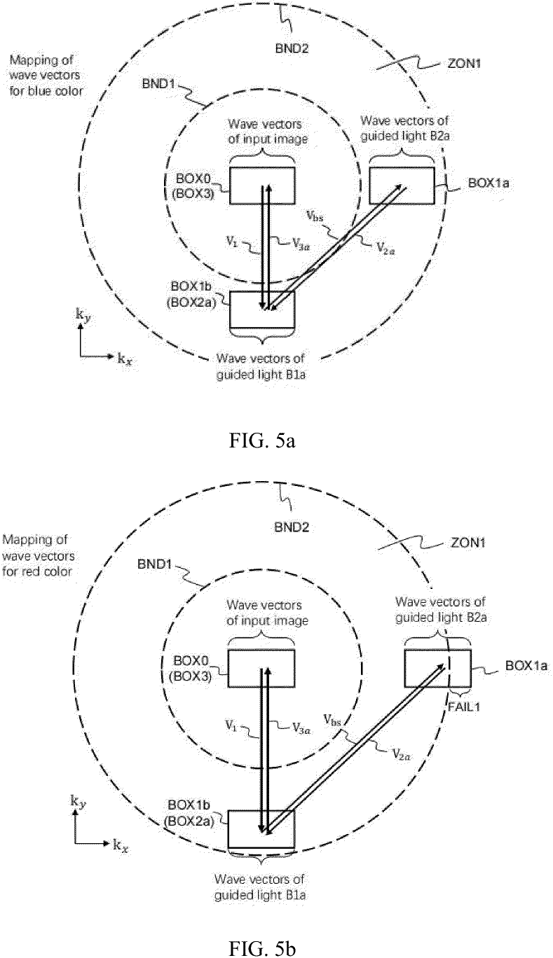

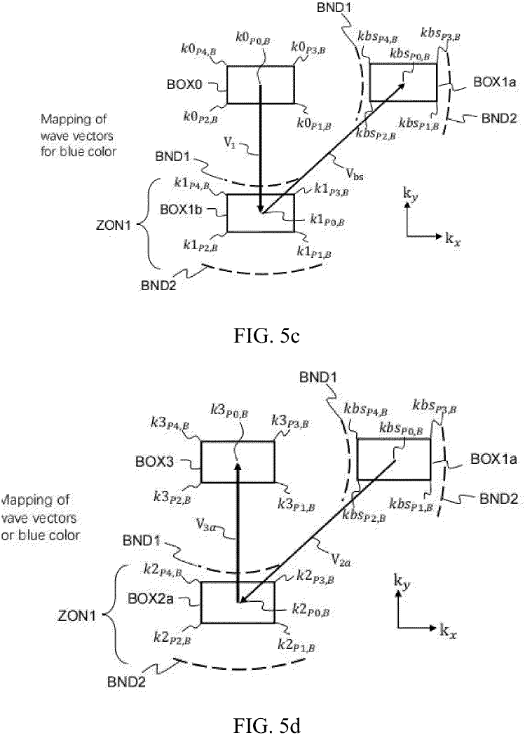

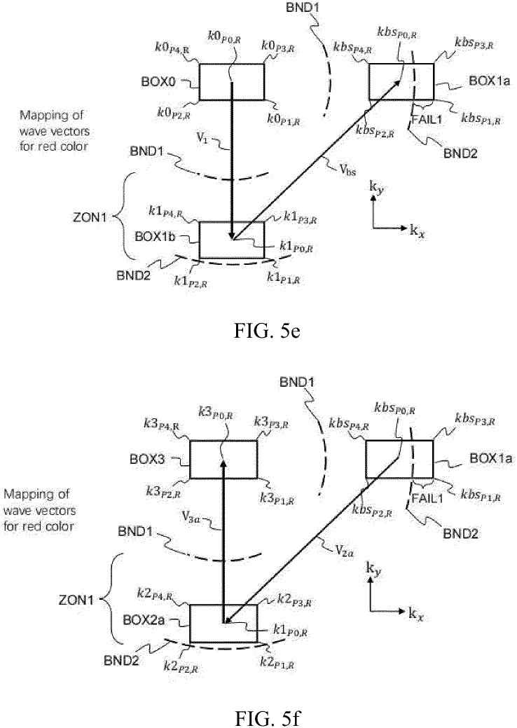

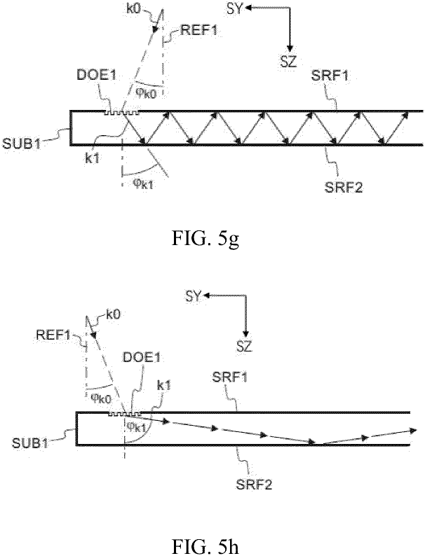

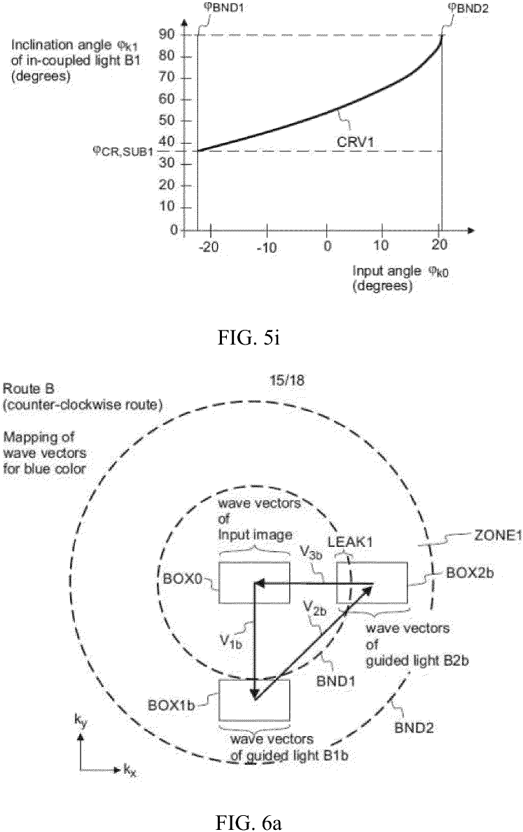

FIG. 5a shows, by way of example, wave vectors for blue light, which propagates within the waveguide plate SUB1 along the first route. The wave vectors of the input light IN1 may be within a region BOX0 of the wave vector space defined by elementary wave vectors kₓ and k_{y}. Each corner of the region BOX0 may represent a wave vector of light of a corner point of an input image IMGO.

The wave vectors of the first guided light B1b may be within a region BOX1b. The wave vectors of the second guided light B1a may be within a region BOX1a.

The wave vectors of the third guided light B2a may be within a region BOX2a.

The wave vectors of the first output light 0133a may be within a region BOX3,

The in-coupling element DOE1 may form the first guided light B1b by diffracting the input light IN1. The diffraction may be represented by adding the grating vector m₁ V₁ of the in-coupling element DOE1 to the wave vectors of the input light IN1. The wave vectors of the second guided light B1a may be determined by adding the grating vector m_{bs} V_{bs} to the wave vectors of the first guided light B1b. The wave vectors of the third guided light B2a may be determined by adding the grating vector m₂ₐ V₂ₐ to the wave vectors of the second guided light B1a. The wave vectors of the first output light OB3a may be determined by adding the grating vector m₃ₐ V₃ₐ to the wave vectors of the third guided light B2a.

BND1 denotes a first boundary for fulfilling the criterion of total internal reflection (TIR) in the waveguide plate SUB1. BND2 denotes a second boundary of maximum wave vector in the waveguide plate SUB1. The maximum wave vector may be determined by the refractive index of the waveguide plate. Light may be waveguided in the waveguide plate SUB1 only when the wave vector of said light is in the region ZONE1 between the first boundary BND1 and the second boundary BND2. The light may leak out of the waveguide plate or not propagate at all if the wave vector of the light is outside the region ZONE1.

The grating period d₁ of the in-coupling element DOE1 may be selected e.g. such that all wave vectors of the first guided light B1b of all colors are within the region ZONE1 defined by the boundaries BND1, BND2.

The grating period d_{bs} of the beam-split element DOEbs may be selected e.g. such that all wave vectors of the blue second guided light B1a are within the region ZONE1 defined by the boundaries BND1, BND2.

FIG. 5b shows, by way of example, wave vectors for red light which propagates within the waveguide plate SUB1 along the first route.

Now, if the grating period d₁ₐ of the in-coupling element DOE1 has been selected such that all wave vectors of the blue second guided light B1a are within the region ZONE1, then the wave vectors of red light of some corner points may be outside the region ZONE1. In other words, the waveguide plate SUB1 cannot confine or guide the red light of some corner points of the input image IMGO.

Wave vectors residing within the sub-region FAIL1 of the region BOX1a may correspond to a situation where the in-coupling element DOE1 fails to form guided light by diffracting the input light. In other words, the diffraction equation does not provide a real practical solution for wave vectors residing within the sub-region FAIL1 of the region BOX1a. Thus, for some image points, it is not possible to couple red light into the waveguide plate, in a situation where the wave vectors of the guided light would be outside the region ZONE1.

For some (other) image points, the leaking of the red light may limit the angular width of the displayed virtual image VIMG1, in a situation where the wave vectors of the guided light would be outside the region ZONE1.

Thus, the boundaries BND1, BND2 of the region ZONE1 may limit the angular width (Δφ) of the displayed virtual image VIMG1. Formation of a wave vector, which is outside the region ZONE1 may mean leakage of light out of the waveguide plate or failed coupling of light into the waveguide plate.

kₓ denotes a direction in the wave vector space, wherein the direction kₓ is parallel with the direction SX of the real space. k_{y} denotes a direction in the wave vector space, wherein the direction k_{y} is parallel with the direction SY of the real space. The symbol k_{z} (not shown in the drawings) denotes a direction in the wave vector space, wherein the direction kz is parallel with the direction SZ of the real space. A wave vector k may have components in the directions kₓ, k_{y}, and/or kz.

FIGS. 5c and 5d show, by way of example, the wave vectors of blue light of the image points (P0, P1, P2, P3, P4) in the wave vector space.

FIGS. 5e and 5f show, by way of example, the wave vectors of red light of the image points (P0, P1, P2, P3, P4) in the wave vector space.

FIG. 5g shows, by way of example, in a cross-sectional side view, forming first guided light by coupling input light into the waveguide plate, wherein the inclination angle _{φk1} of the first guided light is close to the critical angle _{φCR},_{SUB1} of total internal reflection. The situation of FIG. 5g may correspond to operation near the first boundary BND1 of the region ZONE1.

FIG. 5h shows, by way of example, in a cross-sectional side view, forming first guided light by coupling input light into the waveguide plate, wherein the inclination angle φₖ₁ of the first guided light is close to 90 degrees. The situation of FIG. 5h may correspond to operation near the second boundary BND2 of the region ZONE1.

The curve CRV1 of FIG. 5i shows, by way of example, the inclination angle φₖ₁ of the wave vector k1 of first guided light B1a as a function of input angle φₖ₀ of the wave vector k0 of input light B0. The inclination angle φₖ₁ may mean the angle between the wave vector and the reference plane REF1 defined by the directions SZ and SY. The inclination angle φₖ₁ may be calculated from the input angle φₖ₀, from the grating period of the in-coupling element DOE1, and from the refractive index of the waveguide plate SUB1 e.g. by using the diffraction equation. A first angular limit φ_{BND1} may correspond to a situation where the inclination angle φₖ₁ of the first guided light is equal to the critical angle φ_{CR,SUB1} of total internal reflection. A second angular limit φ_{BND2} may correspond to a situation where the inclination angle φₖ₁ of the first guided light is equal to 90 degrees.

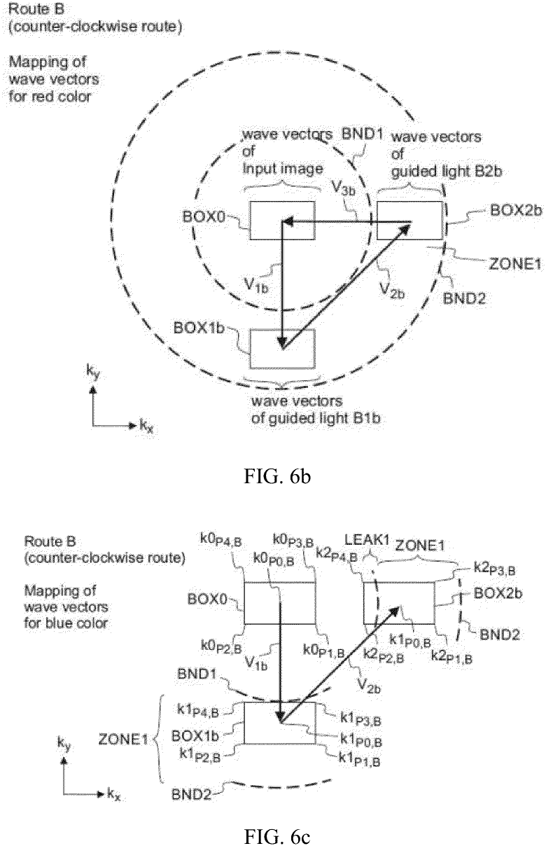

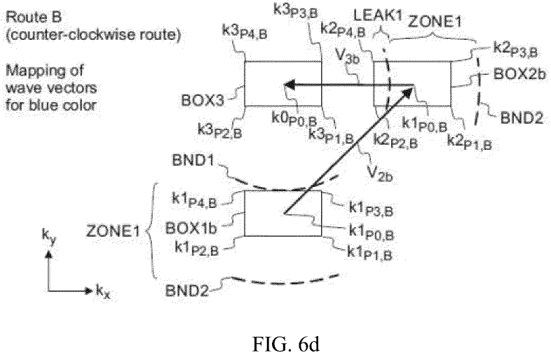

FIG. 6a shows, by way of example, wave vectors for blue light, which propagates within the waveguide plate SUB1 along the second route. The second route may be e.g. a counter-clockwise route.

FIG. 6b shows, by way of example, wave vectors for red light, which propagates within the waveguide plate SUB1 along the second route.

FIGS. 6c and 6d show, by way of example, the wave vectors of blue light of the image points (P0, P1, P2, P3, P4) in the wave vector space.

The grating period d_{2b} of the second expander element DOE2b may be selected e.g. such that all wave vectors of the red fourth guided light B2b are within the region ZONE1 defined by the boundaries BND1, BND2.

Now, if the grating period d_{2b} of the second expander element DOE2b has been selected such that all wave vectors of the red fourth guided light B2b are within the region ZONE1, then the wave vectors of blue light of some corner points may be outside the region ZONE1. In other words, the waveguide plate SUB1 cannot confine the blue light of some corner points of the input image IMG0. The leaking of the blue light may limit the angular width of the displayed virtual image VIMG1. The wave vectors residing in the sub-region LEAK1 of the region BOX2b may represent light, which is not confined to the waveguide plate by total internal reflection.

However, the expander apparatus EPE1 may be arranged to provide both the first route and the second route. The first route may provide the full width (Δφ) of the virtual image VIMG1 at the blue color, and the second route may provide the same full width (Δφ) of the virtual image VIMG1 at the red color. Consequently, the expander apparatus EPE1 may be arranged to display a color virtual image VIMG1, which has the full width (Δφ).

Consequently, the expander apparatus EPE1 may be arranged to display all corner points (P1, P2, P3, P4) of the color virtual image VIMG1 in red color and in blue color, wherein said color virtual image VIMG1 has the full width (Δφ).

Consequently, the angular width (Δφ) of the color virtual image VIMG1 displayed by using the two routes may be substantially greater than a maximum angular width (LIM1) of another color virtual image, which can be displayed by an expander apparatus (EPE0) without using the second route.

The expander apparatus EPE1 with the two routes may be arranged to display a color virtual image VIMG1, which has an extended angular width (Δφ). The first route may be arranged to confine the blue color components of the input image, while allowing leakage of red light of one or more corner points of the input image. The second route may be arranged to confine the red color components of the input image, while allowing leakage of blue light of one or more corner points of the input image.

The display apparatus 500 may be e.g. a virtual reality device 500. The display apparatus 500 may be e.g. an augmented reality device 500. The display apparatus 500 may be a near eye device. The display apparatus 500 may be a wearable device, e.g. a headset. The display apparatus 500 may comprise e.g. a headband by which the display apparatus 500 may be worn on a user’s head. During operation of the display apparatus 500, the out-coupling element DOE3 may be positioned e.g. in front of the user’s left eye EYE1 or right EYE1: The display apparatus 500 may project output light OUT1 into the user’s eye EYE1. In an embodiment, the display apparatus 500 may comprise two optical engines ENG1 and/or two expander apparatuses EPE1 to display stereo images. In an augmented reality device 500, the viewer may also see real objects and/or environment through the expander apparatus EPE1, in addition to the displayed virtual images. The engine ENG1 may be arranged to generate still images and/or video. The engine ENG1 may generate a real primary image IMGO from a digital image. The engine ENG1 may receive one or more digital images e.g. from an internet server or from a smartphone. The display apparatus 500 may be a smartphone. The displayed image may be viewed by a human. The displayed image may also be viewed e.g. by an animal, or by a machine (which may comprise e.g. a camera).

The term k-vector may mean the same as the term “wave vector”.

For the person skilled in the art, it will be clear that modifications and variations of the apparatuses according to the present invention are conceivable. The figures are schematic. The particular embodiments described above with reference to the accompanying drawings are illustrative only and not meant to limit the scope of the invention, which is defined by the appended claims.

What is claimed is:

1. An optical expander apparatus (EPE1), comprising a waveguide plate (SUB1), which in turn comprises:
an in-coupling element (DOE1) to form first guided light (B1b) by diffracting input light (IN1),
a beam-split element (DOEbs) to form second guided light (B1a) by diffracting the first guided light (B1b), to enhance an energy input to the first guided light (B1b) and the second guided light (B1a);
a first expander element (DOE2a) to form third guided light (B2a) by diffracting the second guided light (B1a),
a second expander element (DOE2b) to form fourth guided light (B2b) by diffracting the first guided light (B1b), and
an out-coupling element (DOE3) to form first output light (OB3a) by diffracting the third guided light (B2a), and to form second output light (OB3b) by diffracting the fourth guided light (B2b),
wherein the out-coupling element (DOE3) is arranged to form combined output light (OUT1) by combining the first output light (OB3a) with the second output light (OB3b),
wherein the beam-split element (DOEbs) has a same first grating period (d2a) as the first expander element (DOE2a), and the second expander element (DOE2b) has a different second grating period (d2b) from the first expander element (DOE2a).

2. The optical expander apparatus (EPE1) of claim 1, wherein the beam-split element (DOEbs) has a third grating period different from the first grating period (d2a).

3. The optical expander apparatus (EPE1) of claim 1, wherein, in an instance in which the input light (IN1) corresponds to an input image (IMG0), and the width (Δφ) of the input image (IMG0) is greater than a predetermined limit (LIM1), the elements may be arranged to provide:
red light (B1a_{P1,R}) which -corresponds to a first corner point (P1) of the input image (IMG0),
wherein grating vectors (m₁V₁, m_{bsVbs}, m₂ₐV₂ₐ, m_{2b}V_{2b}, m₃ₐV₃ₐ, M_{3b}V_{3b}) of the elements (DOE1, DOEbs, DOE2a, DOE2b, DOE3) have been selected such that:
the red light of the first corner point (P1) is guided from the in-coupling element (DOE1) to the out-coupling element (DOE3) via the beam-split element (DOEbs) and the second expander element (DOE2b),
the red light of the first corner point (P1) is not guided from the in-coupling element (DOE1) to the out-coupling element (DOE3) via the beam-split element (DOEbs) and the first expander element (DOE2a).

4. The optical expander apparatus (EPE1) of claim 2, wherein, in an instance in which the input light (IN1) corresponds to an input image (IMG0), and the width (Δφ) of the input image (IMG0) is greater than a predetermined limit (LIM1), the elements may be arranged to provide:
red light (B1a_{P1,R}) which corresponds to a first corner point (P1) of the input image (IMG0),
wherein grating vectors (m₁V₁, m_{bs}V_{bs}, m₂ₐV₂ₐ, m_{2b}V_{2b}, m₃ₐV₃ₐ, M_{3b}V_{3b}) of the elements (DOE1, DOEbs, DOE2a, DOE2b, DOE3) have been selected such that:
the red light of the first corner point (P1) is guided from the in-coupling element (DOE1) to the out-coupling element (DOE3) via the beam-split element (DOEbs) and the second expander element (DOE2b),
the red light of the first corner point (P1) is not guided from the in-coupling element (DOE1) to the out-coupling element (DOE3) via the beam-split element (DOEbs) and the first expander element (DOE2a).

5. The optical expander apparatus (EPE1) according to claim 1, wherein, in an instance in which the input light (IN1) corresponds to an input image (IMG0), and the width (Δφ) of the input image (IMG0) is greater than a predetermined limit (LIM1), the elements are arranged to provide:
red light (B1a_{P1,R}) which corresponds to a first corner point (P1) of the input image (IMG0),
blue light (B1a_{P1,B}) which corresponds to a second corner point (P2) of the input image (IMGO),
wherein grating vectors (m₁V₁, m_{bs}V_{bs}, m₂ₐV₂ₐ, m_{2b}V_{2b}, m₃ₐV₃ₐ, m_{3b}V_{3b}) of the elements (DOE1, DOEbs, DOE2a, DOE2b, DOE3) have been selected such that:
the red light of the first corner point (P1) is guided from the in-coupling element (DOE1) to the out-coupling element (DOE3) via the beam-split element (DOEbs) and the second expander element (DOE2b),
the red light of the first corner point (P1) is not guided from the in-coupling element (DOE1) to the out-coupling element (DOE3) via the beam-split element (DOEbs) and the first expander element (DOE2a),
the blue light of the second corner point (P2) is guided from the in-coupling element (DOE1) to the out-coupling element (DOE3) via the beam-split element (DOEbs) and the first expander element (DOE2a), and
the blue light of the second corner point (P2) is not guided from the in-coupling element (DOE1) to the out-coupling element (DOE3) via the beam-split element (DOEbs) and the second expander element (DOE2b).

6. The optical expander apparatus (EPE1) according to claim 2, wherein, in an instance in which the input light (IN1) corresponds to an input image (IMG0), and the width (Δφ) of the input image (IMG0) is greater than a predetermined limit (LIM1), the elements are arranged to provide:
red light (B1a_{P1,R}) which corresponds to a first corner point (P1) of the input image (IMG0),
blue light (B1a_{P1,B}) which corresponds to a second corner point (P2) of the input image (IMG0);
wherein grating vectors (m₁V₁, m_{bs}V_{bs}, m₂ₐV₂ₐ, m_{2b}V_{2b}, m₃ₐV₃ₐ, M_{3b}V_{3b}) of the elements (DOE1, DOEbs, DOE2a, DOE2b, DOE3) have been selected such that:
the red light of the first corner point (P1) is guided from the in-coupling element (DOE1) to the out-coupling element (DOE3) via the beam-split element (DOEbs) and the second expander element (DOE2b),
the red light of the first corner point (P1) is not guided from the in-coupling element (DOE1) to the out-coupling element (DOE3) via the beam-split element (DOEbs) and the first expander element (DOE2a),
the blue light of the second corner point (P2) is guided from the in-coupling element (DOE1) to the out-coupling element (DOE3) via the beam-split element (DOEbs) and the first expander element (DOE2a), and
the blue light of the second corner point (P2) is not guided from the in-coupling element (DOE1) to the out-coupling element (DOE3) via the beam-split element (DOEbs) and the second expander element (DOE2b).

7. The optical expander apparatus (EPE1) according to claim 1, wherein
the first guided light (B1b) comprises light (B1b_{P0}) which corresponds to a center point (P0) of the input image (IMG0),
the second guided light (B1a) comprises light (B1a_{P0}) which corresponds to the center point (P0) of the input image (IMG0),
the third guided light (B2a) comprises light (B2a_{P0}) which corresponds to the center point (P0) of the input image (IMG0),
the fourth guided light (B2b) comprises light (B2b_{P0}) which corresponds to the center point (P0) of the input image (IMG0),
wherein the out-coupling element (DOE3) is arranged to:
form a first output light beam (OB3a) by diffracting a light beam which corresponds to the center point (P0) of the input image (IMG0),
form a second output light beam (OB3b) by diffracting the light beam which corresponds to the center point (P0) of the input image (IMG0),
wherein the first output light beam (OB3a) and the second output light beam (OB3b) propagate in a direction (k0_{P0}) which corresponds to the center point (P0).

8. The optical expander apparatus (EPE1) according to claim 2, wherein
the first guided light (B1b) comprises light (B1b_{P0}) which corresponds to a center point (P0) of the input image (IMG0),
the second guided light (B1a) comprises light (B1a_{P0}) which corresponds to the center point (P0) of the input image (IMG0),
the third guided light (B2a) comprises light (B2a_{P0}) which corresponds to the center point (P0) of the input image (IMG0),
the fourth guided light (B2b) comprises light (B2b_{P0}) which corresponds to the center point (P0) of the input image (IMG0),
wherein the out-coupling element (DOE3) is arranged to:
form a first output light beam (OB3a) by diffracting a light beam which corresponds to the center point (P0) of the input image (IMG0),
form a second output light beam (OB3b) by diffracting the light beam which corresponds to the center point (P0) of the input image (IMG0),
wherein the first output light beam (OB3a) and the second output light beam (OB3b) propagate in a direction (k0_{P0}) which corresponds to the center point (P0).

9. The optical expander apparatus (EPE1) according to claim 1, wherein the in-coupling element (DOE1) is arranged to diffract the input light (IN1) such that the first guided light (B1b) comprises light of a center point (P0) of an input image (IMG0), and the beam-split element (DOEbs) is arranged to diffract the first guided light (B1b) such that the second guided light (B1a) comprises the light of the center point (P0) of the input image (IMG0),
wherein the out-coupling element (DOE3) is arranged to diffract the third guided light (B2a) received from the first expander element (DOE2a) such that the first output light (OB3a) comprises the light of the center point (P0) of the input image (IMG0),
wherein the out-coupling element (DOE3) is arranged to diffract the fourth guided light (B2b) received from the second expander element (DOE2b) such that the second output light (OB3b) comprises the light of the center point (P0) of the input image (IMG0),
wherein the light of the center point (P0) in the first output light (OB3a) propagates in an axial direction (k3,P0), wherein the light of the center point (P0) in the second output light (OB3b) propagates in the same axial direction (k3,P0).

10. The optical expander apparatus (EPE1) according to claim 2, wherein the in-coupling element (DOE1) is arranged to diffract the input light (IN1) such that the first guided light (B1b) comprises light of a center point (P0) of an input image (IMG0), and the beam-split element (DOEbs) is arranged to diffract the first guided light (B1b) such that the second guided light (B1a) comprises the light of the center point (P0) of the input image (IMG0),
wherein the out-coupling element (DOE3) is arranged to diffract the third guided light (B2a) received from the first expander element (DOE2a) such that the first output light (OB3a) comprises the light of the center point (P0) of the input image (IMG0),
wherein the out-coupling element (DOE3) is arranged to diffract the fourth guided light (B2b) received from the second expander element (DOE2b) such that the second output light (OB3b) comprises the light of the center point (P0) of the input image (IMG0),
wherein the light of the center point (P0) in the first output light (OB3a) propagates in an axial direction (k3,P0), wherein the light of the center point (P0) in the second output light (OB3b) propagates in the same axial direction (k3,P0).

11. The optical expander apparatus (EPE1) according to claim 1, comprising one or more optically isolating elements (ISO1) to prevent direct optical coupling between the first expander element (DOE2a) and the second expander element (DOE2b).

12. The optical expander apparatus (EPE1) according to claim 2, comprising one or more optically isolating elements (ISO1) to prevent direct optical coupling between the first expander element (DOE2a) and the second expander element (DOE2b).

13. A display apparatus (500) comprising an optical engine (ENG1) to form an primary input image (IMGO) and to convert the input primary image (IMG0) into a plurality of input light beams of the input light (IN1), the display apparatus (500) comprising the optical expander apparatus device (EPE1) to form light beams of combined output light (OUT1) by diffractively expanding the input light beams of the input light (IN1); and the optical expander apparatus (EPE1), comprising a waveguide plate (SUB1), which in turn comprises:
an in-coupling element (DOE1) to form first guided light (B1b) by diffracting input light (IN1),
a beam-split element (DOEbs) to form second guided light (B1a) by diffracting the first guided light (B1b), to enhance an energy input to the first guided light (B1b) and the second guided light (B1a);
a first expander element (DOE2a) to form third guided light (B2a) by diffracting the second guided light (B1a),
a second expander element (DOE2b) to form fourth guided light (B2b) by diffracting the first guided light (B1b), and
an out-coupling element (DOE3) to form first output light (OB3a) by diffracting the third guided light (B2a), and to form second output light (OB3b) by diffracting the fourth guided light (B2b),
wherein the out-coupling element (DOE3) is arranged to form combined output light (OUT1) by combining the first output light (OB3a) with the second output light (OB3b),
wherein the beam-split element (DOEbs) has a same first grating period (d2a) as the first expander element (DOE2a), and the second expander element (DOE2b) has a different second grating period (d2b) from the first expander element (DOE2a).
